(19) United States
(12) Patent Application Publication
(10) Pub. No.: US 2008/0197069 A1
(43) Pub. Date: Aug. 21, 2008

(54) Ceramic Filter Element for Water Purification

(76) Inventors: Olaf Binkle, Kirkel (DE); Ralph Nonninger, Saabruecken (DE); Harald Rohde, Nieheim (DE)

Correspondence Address: KOHLER SCHMID MOEBUS, RUPPMANNSTRASSE 27, D-70565 STUTTGART, omitted

(21) Appl. No.: 10/565,795

(22) PCT Filed: Jul. 28, 2004
(86) PCT No.: PCT/DE2004/001682

§ 371 Date: Mar. 31, 2008

(30) Foreign Application Priority Data
Aug. 1, 2003 (DE) 103 35 343.7

(51) Int. Cl. B01D 71/06

(52) U.S. Cl. 210/500.27

(57) ABSTRACT

In a ceramic filter element 10 for purifying water, the element is formed by a tubular body, which comprises at least one wall 11 and has at least one through opening 12 extending along the entire length of the tubular body. The wall 11 is implemented as a functional layer or as a carrier having a functional coating and either the water to be filtered flows, under pressurize, through the outer surface 18 and discharges into the through opening 12 or the water to be filtered flows, under pressurized, from the inner surface 17 of the through opening 12 to the outer surface 18 of the ceramic filter element 10.

### PRIOR ART

The present invention concerns a ceramic filter element for purifying water, which may be used as a filter element, with and without a housing.

In many countries, supplying the population with drinking water represents the greatest problem of the future. Especially in conurbations or in unpopulated areas, the drinking water is often contaminated with dirt and pathogens, such as bacteria, viruses, and spores. Diarrhea, cholera, typhus, hepatitis, polio, or tetanus are only a few examples of illnesses which may be transmitted through infected drinking water and from which three to four million children, among others, die worldwide each year. In particular in the urban areas of developing countries, up to 90% of the sewage reaches rivers or the groundwater in an untreated state. The World Health Organization expects that, in the year 2050, nearly half of the world population (44%) will no longer have access to clean water.

Since it is already assumed that in the 21st-century most wars will be waged with the goal of obtaining access to clean water, the drinking water problem is being dealt with worldwide. For example, attempts are being made to ensure sufficient sewage treatment facilities, to desalinate seawater, and to establish chemical disinfection plants using chlorine or ozone. The fact that many hotels of the world warn people not to drink the tap water illustrates, among other things, that these problems have not been solved. These warnings may be seen in the USA as well as in Russia or China. Only in central, western, and northern Europe does tap water have good drinking quality. However, water preparation agents such as chlorine or silver ions are also required at these locations if the water is stored for a long time, e.g., in water tanks.

Sewage treatment plants, seawater desalination facilities, etc., are used for the purpose of dealing with the water problems on a large scale. However, since these measures are very costly, more than half of the world population already lives with poor quality, usually infected, drinking water. In countries such as China, drinking water is sold in canisters at the market. The needs of individuals for clean drinking water do not therefore begin far from civilization where the drinking water may only be obtained from ponds, brooks, springs, wells, or rivers, but rather also within populated regions.

For the outdoor field, drinking water filters have already been introduced at an early time, which are handy and robust and fit into any backpack. The world market leader for such mobile filter systems is the Katadyn company, who sells such products today under the name “Certipur”. These filters have a porous container in their interior made of plastic (polymer) or diatomaceous earth which is, for example, equipped with activated carbon and silver compounds and through which the contaminated water is pumped. Due to its immense surface area, the activated carbon in the interior of the porous container absorbs the germs and separates them from the water. The silver is used for the purpose of killing the germs. Such filters were especially developed for trekkers and conceived for expeditions. They withstand extreme stresses, but are complex and costly and have therefore not been developed for mass applications.

There has been no lack of experiments for producing filters which are also suitable for mass applications and which may supply individuals with clean water. These filters are nearly exclusively used in stationary water preparation facilities which are integrated into the water line, upstream of the tap, and chemically or physically disinfect the water. An exception here is the water filter from Brita, which works on the basis of an ion exchanger and is operated as a mobile facility in the kitchen (analogously to a coffee machine), for example. These systems have the common features of being complex and expensive.

Simple devices which are relatively cost-effective work on the basis of a porous polymer filter that is combined with activated carbon (Filtrix, daughter company of one of the largest producers of activated carbon, Norit or Smith Hodgins). However, since the polymers are not designed for high temperatures, mechanical stresses (e.g. cleaning), and acid and/or basic water, their field of use is strongly limited. Such filters may not be used for seawater, brackish water, water containing carbon dioxide, or water containing sugar. However, the greatest problem of these filters is that they may only be cleaned with difficulty (if at all, using chemical cleaners) or are simply sold as disposable products.

In order to avoid the latter disadvantages and particularly the difficulty of cleaning, Doulton uses ceramic cartridges as an external sleeve in their filters. In their product descriptions, Doulton, among others, suggests that these ceramic cartridges be cleaned with abrasive paper under the tap after use. These cartridges, which do not have any type of filter function, are water permeable and contain silver ions to promote disinfection. These cartridges are filled with the actual filter material, activated carbon, which may absorb the contaminants because of its high surface area and thereby purifies the water.

In summary, it may be said that clean drinking water is rare worldwide and over 40% of the world population will no longer have access to clean drinking water by 2050. Sewage treatment facilities, seawater desalination facilities, etc., deal with this problem, but the problem has not been solved universally because of high costs and political conditions. Only in northern, central, and western Europe does drinking water have good quality.

In order to supply individuals with high-quality drinking water, there are costly and complex outdoor solutions which are not conceived for mass applications. These solutions work with activated carbon, which absorbs the bacteria from the contaminated water in view of its high surface area, and with silver, which kills the bacteria. Furthermore, stationary and mobile facilities are known which also clean the water using activated carbon or ion exchangers. These very complex and costly systems render mass applications difficult or inconceivable, particularly in poorer countries. However, approaches which separate bacteria beginning with polymer filters, in addition to the use of activated carbon, are interesting.

The polymer filters may have widely ranging pore sizes, but are very susceptible to breakdown when used as a filter material. Their operation (complex pumping through of contaminated water) is also very cumbersome and only chemical cleaning is possible, if at all.

The object of the present invention is to develop a novel water filter which has a simple, cost-effective separation principle, allows easy handling, is mechanically, chemically, and physically stable throughout a large temperature range, and is also easy to clean.

The object is achieved by a ceramic filter element, comprising a tubular body which is formed by at least one wall and having at least one through opening extending along the entire length of the tubular body, the at least one wall being implemented as a functional layer or as a carrier having a functional coating, wherein the water to be filtered flows under pressure either from the outer surface into the through opening or via the inner surface of the through opening to the outer surface of the ceramic filter element.

According to the present invention, the ceramic filter element is installed in a housing which has a water outlet and a water inlet, preferably on an first open end of the through opening, the housing having a closure screw which closes an open second end of the through opening.

In this context, a functional layer is understood to define a ceramic molded body or a ceramic layer of arbitrary thickness, with which the filtering function is effected. The thickness of the wall may change over the cross-section of the filter element.

With these features, a ceramic filter element is provided that may be produced with compact construction, for example, having a diameter of 2.5 cm to 3.5 cm and a length of approximately 15 cm. It is therefore also easy to transport. The ceramic filter element according to the present invention is usable for the filtration of arbitrarily soiled water and may be operated in greatly varying ways. It is mechanically stable compared to polymer filters, is chemically inert, and is resistant to high temperatures. Furthermore, the pore size distribution of the ceramic filter element may be tailored very easily via the temperature during sintering (firing) as can the particle size of the materials used in the ceramic filter element according to the present invention, so that, for example, bacteria or virus filters may also be produced. Of course, these ceramic filter elements may also optionally be provided with compounds containing silver ions, which, in turn, have a bactericidal effect.

The ceramic filter element may be easily cleaned through brushing, back-flushing, or by boiling in water and is suitable for long-term use without restriction. Cleaning is also possible via chemical treatments, e.g., using oxidation agents or acids. The through opening, through which flushing of the filter element is made possible without complete disassembly, is opened by unscrewing the closure screw. The closure screw is removed from the housing and, for cleaning purposes, liquid may flow through the ceramic filter element along its entire axial length. In particular, if the water to be filtered flows via the inner surface of the through opening to the outer surface of the ceramic filter element, residues remaining in the through opening may thereby be easily removed.

If the ceramic filter element is implemented as a rod-shaped element, which is circular in cross-section and having multiple through openings, a large filter area may be provided with the smallest of external dimensions.

The ceramic filter element is produced via a sintering process from the chemical compound group comprising chalcogenides, preferably oxides and/or sulfides and/or carbides or nitrides. These are, for example, (possibly hydrated) oxides of the following elements, for example: Zn, Ce, Sn, Al, B, Si, Ti, Zr, Y, La, Fe, Cu, Ag, Ta, Nb, V, Mo, or W, preferably ZrO₂, Al₂O₃, TiO₂, CeₓO_{y}, FeₓO_{y}, ZnO, Y₂O₃, SnO₂, and SiO₂, but also phosphates, silicates, aluminates, and stannates, such as barium stannate, sulfides of Zn and Ag, for example, carbides of W or Si, for example, nitrides of Al, Si, or Ti, for example, corresponding mixed oxides, such as metal-tin oxides, e.g., indium-tin oxide (ITO), antimony-tin oxide (ATO), fluorine-doped tin oxide, and zinc-doped aluminum oxide or mixed oxides such as BaTiO₃. Mixtures of these powders may also be used. The ceramic filter elements according to the present invention may be produced exclusively from the above-mentioned mixtures or the ceramic filters are coated on the inner and/or outer surface, the individual coatings comprising the above-mentioned powder mixtures.

If coatings are used, the coating thicknesses are preferably 100 nm to 200 μm. Coating thicknesses of 2 μm to 100 μm are preferably used.

If the ceramic filter elements according to the present invention are produced exclusively from a functional layer, the functional layer may be porous, having pores in the size range from 100 nm to 10 μm, in dependence on the application. The selected pore distribution may be very narrow or may also be broadly scattered, as needed. If the ceramic filter elements according to the present invention are produced from a carrier and a functional coating, the carrier typically has a pore size from 1 to 2 μm and the coating has a pore size which is always smaller than the particles of the material to be filtered out.

In a further embodiment, the ceramic filter element according to the present invention has a mouthpiece. In this embodiment, the ceramic filter element may also be operated by applying a vacuum. In the simplest case, this is performed by immersing a closed end, i.e., preferably the end closed by the closure screw, of the ceramic filter element in contaminated water and implementing a mouthpiece on the open end of the ceramic filter element. In this context, the ceramic filter element according to the present invention may be used like a drinking straw. Embodiments without a mouthpiece are also conceivable.

Because the ceramic filter element is installed in a housing which has a water inlet and a water outlet, it may be screwed onto any tap and is thus capable of wide-spread use and is extremely user-friendly. Typical pressures from water pipelines of 2 to 6 bar are sufficient for filtration of the contaminated water. Preferably, quick-acting closures for coupling to fittings and/or hoses may be attached and/or implemented on the housing cover and/or housing body. This has the advantage that the ceramic filter element according to the present invention may be connected to any common water supply. This may be performed via a screw closure or via a quick-acting closure (e.g., Gardena system) or any type of closures known to those skilled in the art. Of course, the ceramic filter element according to the present invention may be operated even if the pressure conveying the contaminated water does not come from a water line system.

In this context, the housing is preferably formed in multiple parts from a housing cover and a housing body. This has the advantage that the ceramic filter element according to the present invention may be maintained and cleaned as simply as possible. A ceramic filter element which is to be cleaned or replaced may either be replaced by opening the housing. Alternatively, the closure screw may be removed via simple turning to thereby facilitate a very efficient ability to back-flush and clean the filter.

If the housing is constructed in multiple parts, the individual housing parts are removably connected to one another in a liquid-tight fashion. This has the advantage that the ceramic filter element according to the present invention may be operated under pressurize.

If the ceramic filter element is formed by a coarse-pored carrier and a thin functional coating which is responsible for the actual pore size distribution, the water to be filtered may advantageously flow through the course-pored carrier with less resistance. Using this measure, the flow quantities may be significantly increased relative to fine-pored filter elements which have this fine-pored structure across their entire cross-section, and the efficiency of the ceramic filter element is increased.

In special embodiments, the housing inner surfaces and the ceramic filter element itself may be coated and/or treated with a biocidal material and/or a material containing silver ions. This widens the range of applicability of the ceramic filter element according to the present invention.

Further advantages result from the description of the figures. The features cited above and given below may each be used individually or in any arbitrary mutual combinations. The embodiments cited are not to be understood as an exhaustive enumeration, rather have exemplary character.

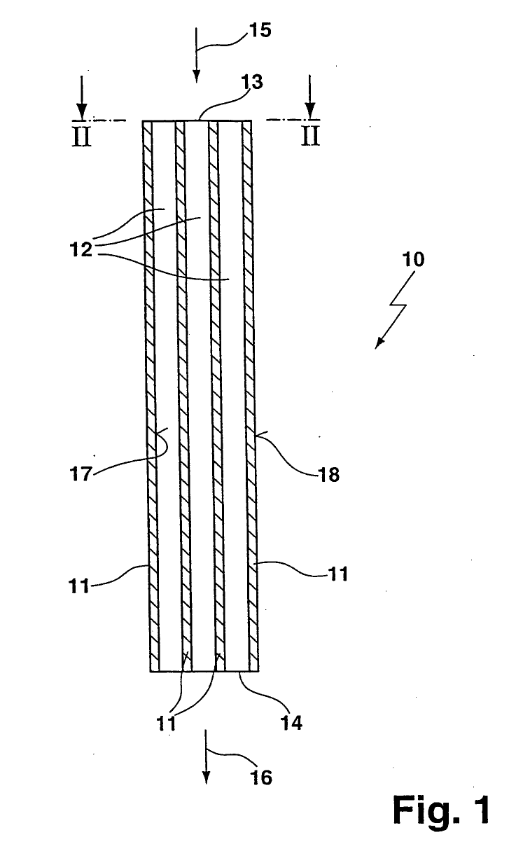

FIG. 1 shows a vertical section through a ceramic filter element according to the present invention;

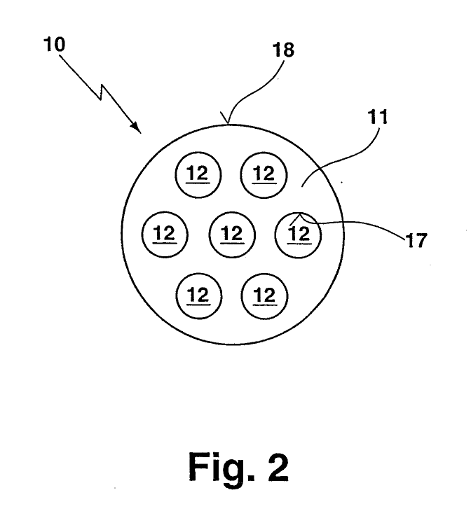

FIG. 2 shows a top view of a complete body of a ceramic filter element according to the present invention, along line II-II of FIG. 1;

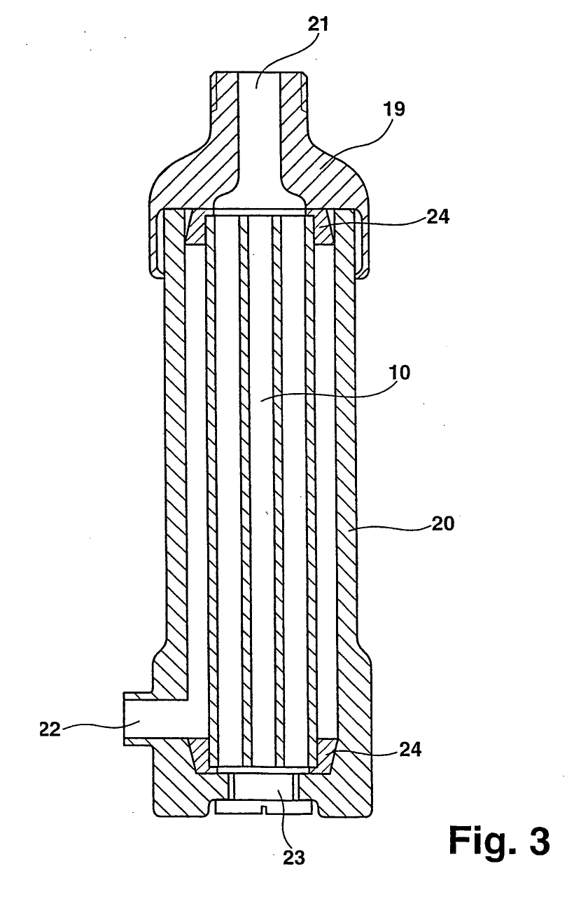

FIG. 3 shows a ceramic filter element according to the present invention installed in a multipart housing having a water inlet and a water outlet;

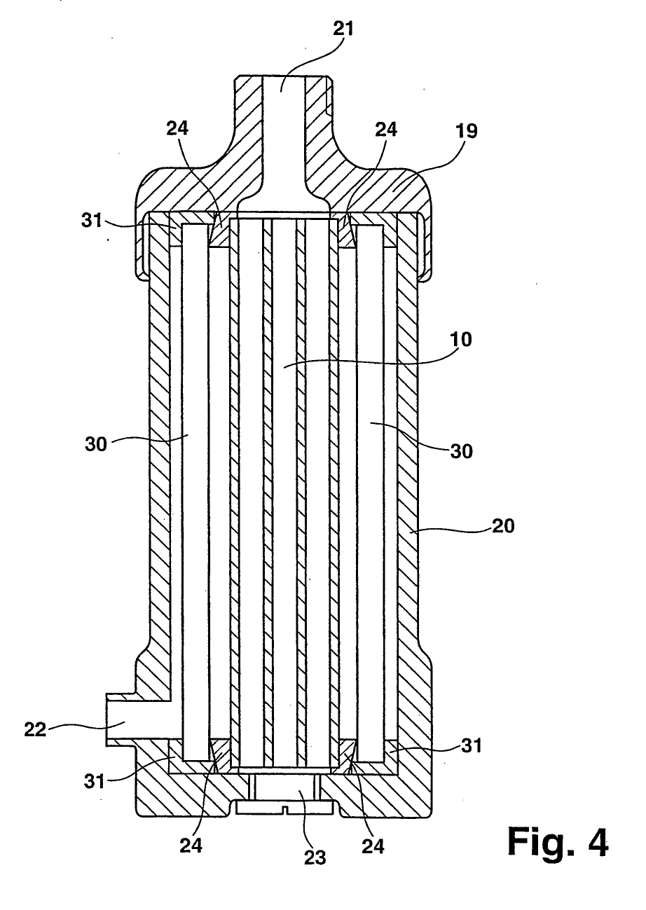

FIG. 4 shows a ceramic filter element according to the present invention having an activated carbon filter element.

The individual figures of the drawing show the object according to the present invention in highly schematic form and are not to scale.

FIG. 1 shows a ceramic filter element 10 in vertical section having walls 11 made of a porous sintered material and through openings 12, through which either the water to be filtered or the filtrate may flow. The ceramic filter element 10 has an open first end 13 and an open second end 14.

Flow directions for the water to be filtered are indicated by the arrows 15 and 16. If one of the ends 13, 14 is closed, water to be filtered may flow, under pressurize, through the walls of an inner surface 17 or an outer surface 18. Depending on the mode of operation, a fine-pored coating may additionally be applied to the inner surface 17 or to the outer surface 18.

FIG. 2 shows a top view of a ceramic filter element according to the present invention, along line II-II of FIG. 1. The ceramic filter element 10 is circular and has multiple through openings 12. Walls 11 are implemented between the individual through openings 12, which are partially or completely used as filter surfaces. The inner surface 17 and/or the outer surface 18 may have functional coatings which are tailored to the application for the particular ceramic filter element 10 according to the present invention.

FIG. 3 shows a longitudinal section of a ceramic filter element 10 according to the present invention, as it is installed in a housing comprising a housing cover 19 and a housing body 20. The housing cover 19 has a water inlet 21 and the housing body 20 has a water outlet 22. The water to be treated flows via the water inlet 21 through the housing cover 19 into the ceramic filter element 10 and leaves the housing via the water outlet 22 as a filtrate. The housing itself is pressure-stable and may be manufactured from plastic or metal. A closure screw 23 is provided on the lower end of the housing body 20 and may be unscrewed from the housing body 20 for back-flushing and for cleaning the ceramic filter element 10. The ceramic filter element 10 is inserted into the housing body 20 and into the housing cover 19 via seals 24 and the closure screw 23 is also screwed into the housing body 20 in a liquid-tight manner.

Quick-acting closures and/or corresponding coupling systems may be attached to the free end of the housing cover 19 and to the free end of the water outlet 22, so that these housing parts may be attached as easily as possible to a tap and/or to existing hose systems. The housing cover 19 is connected to the housing body 20 in a removable, but liquid-tight and pressure-tight manner.

FIG. 4 shows a ceramic filter element according to the present invention in longitudinal section. The filter element is constructed in accordance with the filter element illustrated in FIG. 3, but additionally has an activated carbon filter element 30 which encloses the tubular body of the ceramic filter element 10. The activated carbon filter element 30 and the tubular body of the ceramic filter element 10 are integrated in the housing, which has a water inlet 21 and a water outlet 22. The activated carbon filter element 30 is positioned to form a seal around the tubular body of the ceramic filter element 10 using a seal seating 31. The water to be filtered flows under pressurize (i.e. forced flow is used) via the inner surface of the through openings to the outer surface of the tubular body and further through the activated carbon filter element 30, i.e. from the inside to the outside. The water to be purified therefore sequentially flows through the tubular body of the ceramic filter element 10 and the activated carbon filter element 30. The activated carbon filter element may be formed by a loose bulk product of activated carbon. A sealing surface may then be dispensed with. The activated carbon filter element 30 is used, for example, for removing organic flavoring agents and/or chlorine from the water to be filtered.

1-9. (canceled)

10. A ceramic filter element for cleaning water, the element comprising:
a housing, said housing defining a water inlet, a water outlet, and a cleaning outlet;
a tubular body disposed within said housing, said tubular body having at least one wall and at least one through opening extending along an entire length of said tubular body, said at least one wall structured and dimensioned as at least one of a functional layer and as a carrier having a functional coating, said tubular body having an open first end communicating with said inlet and an open second end; and
a closure member, sealing said cleaning outlet and closing said open second end of said tubular body, wherein water to be filtered flows under pressure from an outer surface into said through opening or from an inner surface of said through opening to an outer surface of the filter element.

11. The ceramic filter element of claim 10, wherein the ceramic filter element is implemented as a rod-shaped element which is circular in cross-section, having multiple through openings.

12. The ceramic filter element of claim 10, wherein the ceramic filter element is produced, via a sintering process, from chemical compounds selected from the group consisting of chalcogenides, oxides, sulfides, carbides, and nitrides.

13. The ceramic filter element of claim 10, wherein said tubular body of the ceramic filter element is enclosed by an activated carbon filter element.

14. The ceramic filter element of claim 10, wherein the ceramic filter element has a mouthpiece.

15. The ceramic filter element of claim 10, wherein said housing is formed in multiple parts from a housing cover and a housing body, wherein individual housing parts are removably connected to each another in a liquid-tight manner.

16. The ceramic filter element of claim 15, further comprising attachments or quick-acting closures cooperating with said housing cover and/or said housing body for coupling to fittings or hoses.

17. The ceramic filter element of claim 10, wherein the ceramic filter element is formed from a coarse-pored carrier and a fine-pored functional coating.

18. The ceramic filter element of claim 10, wherein the ceramic filter element is coated and/or treated with a biocidal material and/or a material containing silver ions.
